(19) United States
(12) Patent Application Publication
(10) Pub. No.: US 2023/0417716 A1
(43) Pub. Date: Dec. 28, 2023

(54) COVER FOR A THIN-LAYER CHROMATOGRAPHY DEVELOPMENT CHAMBER

(71) Applicant: MERCK PATENT GMBH, DARMSTADT (DE)

(72) Inventors: Michaela OBERLE, Darmstadt (DE); Eric SCHUNDA, Kronberg Im Taunus (DE); Robert FISCHER, Kronberg Im Taunus (DE)

(73) Assignee: MERCK PATENT GMBH, DARMSTADT (DE)

(21) Appl. No.: 18/036,977

(22) PCT Filed: Nov. 12, 2021
(86) PCT No.: PCT/EP2021/081456

§ 371 Date: May 15, 2023

(30) Foreign Application Priority Data
Nov. 16, 2020 (EP) 20207937.2

(51) Int. Cl. G01N 30/95; B01D 15/18; G01N 30/94

(52) U.S. Cl. CPC G01N 30/95; B01D 15/1842; G01N 30/94

(57) ABSTRACT

A thin-layer chromatography development chamber (1) that can be used for developing thin-layer chromatography plates (21) by introducing a liquid solvent onto a sample arranged on the surface of a thin-layer chromatography plate (21), whereby the solvent and the thin-layer chromatography plate (21) can be inserted into the development chamber (1), comprises a housing (2) with an opening (3). The opening (3) of the development chamber (1) can be closed with a cover (4) that comprises a data input unit (10) for entering or collecting data related to a development process performed within the development chamber (1). The cover (4) further comprises a data communication unit (16) that enables a wireless data transmission of the data related to the development process to a thin-layer chromatography data storage device (24).

### TECHNICAL FIELD

The present invention relates to a cover for a thin-layer chromatography development chamber that allows for developing thin-layer chromatography plates by introducing a liquid solvent onto a thin-layer chromatography plate, whereby the solvent and the thin-layer chromatography plate can be inserted into the development chamber, and whereby an opening of the development chamber can be closed with the cover.

### BACKGROUND

Thin-layer chromatography is a chromatography technique used to separate non-volatile mixtures within a sample, which allows for identifying and possibly quantifying the individual components of the sample. Thin-layer chromatography is usually performed on a thin-layer chromatography plate that can be a plate of glass or plastic or an aluminum foil, which is coated with a thin-layer of adsorbent material, like e.g. a silica gel, aluminum oxide or cellulose. This layer of adsorbent is known as the stationary phase.

After the sample has been applied onto the plate, a solvent or solvent mixture that is known as the mobile phase is drawn up the plate via capillary action. If the sample is applied onto a region close to a border of the plate and the solvent mixture is drawn up from the same border of the plate, the sample is drawn up together with the solvent mixture across the plate. Because different components of the sample, i.e. different analytes ascend the plate at different rates, a separation of the analytes is achieved resulting in different spots along the path of the solvent mixture that is drawn up and travels across the plate.

After such a development of the thin-layer chromatography plates, the spots of the different analytes within a sample are visualized. This can be done by illuminating the plate with visual light or with ultraviolet light. It is also possible to perform chemical processes to visualize spots. The position and the size of these spots on the plate can be used for identification of the analytes as well as for quantitative measurements of the amount of the respective analytes within the sample.

To quantify the results, the distance traveled by the analyte being considered is divided by the total distance traveled by the mobile phase, i.e. the solvent mixture. This ratio is called the retardation factor. Retardation factors are characteristic, but will change depending on the exact condition of the mobile and stationary phase. For this reason, usually a sample of a known compound is combined with one or more samples of interest to the plate before developing the plate and analyzing the results.

Thin-layer chromatography can be used to monitor the progress of a reaction, identify compounds present in a given mixture, and determine the purity of a substance. Thus, thin-layer chromatography is a well-established means for analyzing samples in many different application environments like e.g. research and development as well as monitoring and quality control of industrial manufacturing processes. However, in order to allow for a meaningful comparison of different results of thin-layer chromatography measurements, many parameters like e.g. the plates and the solvent mixture that is used as well as the duration and conditions during the development of the plates should be identical or at least known and taken into consideration for analyzing and comparing the results of thin-layer chromatography measurements. Usually, these parameters must be determined and written down by the persons that perform the development of the thin-layer plates. This is a tedious task, which is error-prone and might result in interfering with the evaluation of measurement results e.g. performed at different times or at different locations.

Accordingly, there is a need for a thin-layer chromatography development chamber that allows for developing thin-layer chromatography plates in a manner that facilitates a meaningful comparison of different measurements at different times or locations.

### SUMMARY OF THE INVENTION

The present invention relates to a cover for a thin-layer chromatography development chamber, whereby that the cover comprises a data input unit for entering or collecting data related to a development process performed within the development chamber. The data input unit can be integrated into the cover in a manner that the data input unit does not interfere with the handling of the cover. The data input unit can comprise an input device with mechanical input facilities like e.g. pushbuttons, keys or rotary knobs. Preferably, the data input unit comprises several membrane keys or a touchscreen for manual entering of data before, during or after performing a development step with the thin-layer chromatography development chamber. Thus, the cover that is used for closing the thin-layer chromatography development chamber and that always must be used and handled during a development step with the development chamber can also be used for entering information related to the specifics of this development like information about the plate, about the solvent mixture and about the sample or the many samples on this plate.

Furthermore, it is also possible to add sensors to the data input unit, i.e. at any position inside or at the surface of the cover that perform measurements and collect data about e.g. the duration or temperature or any other condition during the development step that might be of further interest during analyzation and evaluation of the measurement results. The data acquisition performed by the sensors can be triggered automatically before, during or after a development step. It is also possible for the data acquisition to be triggered manually by a user command before, during or after performing the development step.

It is considered advantageous for avoiding faulty operations or lack of data acquisition during the development of a thin-layer chromatography plate that the cover comprises a status indication unit that indicates an operational state of the cover during use. The status indication unit may comprise an acoustic indicator that reproduces sounds or beeps that indicate e.g. a switch of the operational state from off to on or from on to off. It is also possible to acoustically indicate the results of an automated functioning test that is performed each time the cover is switched on before performing a development of a thin-layer chromatographic plate. It is also possible to comprise a status indication unit with a visual indicator like e.g. a status LED that lights up when the cover is switched on. Different modes of operation or the results of an automated functioning test can be indicated by different status LEDs or by a single status LED with different lightning colors.

According to an aspect of the invention, the cover comprises an information display unit for displaying data that has been entered or collected with the data input unit. The information display unit may comprise a monochromatic or color display. The information display unit may also comprise a bar display or a pointer display. The information display may be configured to display some or all of the data that has been manually entered before, during or after a development step, or that has been collected with appropriate sensors before, during or after a development step.

According to an advantageous aspect of the invention, the cover comprises a data communication unit that enables a wireless data transmission of the data related to the development process to a thin-layer chromatography data storage device. All the data that is either manually entered into the data input unit or collected by the sensors of the data input unit can then be transferred to a thin-layer chromatography data storage device without the need of manual interaction or support by a user. The data transfer can be manually triggered or performed automatically. The data communication unit may comprise standardized communication interfaces like e.g. a WLAN interface, a Bluetooth interface or an NFC interface. It is also possible to make use of an individually configured data communication unit that allows for data transfer from the data input unit to a data storage that might be near to the cover or far away from the cover. It is also possible to provide for a data transmission by using a first data transmission protocol for a first data transmission from the cover to an additional data transmission device that acts as a router and that is located near the development chamber, i.e. within the same room, and then to transmit the data using a second and different data transmission protocol from the additional data transmission device to the storage device that can be located anywhere and far away from the development chamber.

The thin-layer chromatography data storage device can be a separate storage device that only stores the data without further evaluation or manipulation of such data. Such a storage device can be accessed from other devices like e.g. thin-layer chromatography evaluation devices for retrieving the stored data from the storage device for evaluation purposes. It is also possible that the storage device is integrated into a thin-layer chromatography evaluation device. The storage device may be integrated within any device, with which a data evaluation or data preparation of the data from the cover can be performed. Furthermore, the storage device may also be integrated into any device that can be used for performing any desired step during the development and analysis of the thin-layer chromatography plate. The storage device may comprise a volatile memory only into which the data is transmitted and stored for a short period of time. For most applications it is advantageous to make use of a storage device that is suitable for and configured to perform a long-term storage of the data.

According to an embodiment of the invention, the data input unit of the cover comprises a timer device that can be set, e.g. through an external separate instrument via a wireless connection, to indicate the development process duration. The timer device provides information for a user during the development step and can indicate the expiration of the preset development process duration which facilitates to terminate the development process immediately after the preset process duration. Furthermore, it is possible to automatically collect the preset process duration as a data for the data input unit that will be transmitted and stored for this development step within the thin-layer chromatography data storage device. If more than one development chamber is used at the same time, the integration of such a timer device into the cover facilitates the handling of each of the development chambers and avoids a confusion that might arise from the use of an external timer device that is not clearly assigned to a single development chamber.

Furthermore, it is possible to combine the timer device with a sensor device that monitors the connection of the cover with the housing of the development chamber, i.e. the duration between closing the housing of the development chamber with the cover until reopening the housing of the development chamber for the removal of one or more plates after performing the development step of the respective plates. Thus, the duration of the development step of the plates can be automatically determined and monitored by the data input unit. It is also possible to provide for a plate reception device at the cover that allows for mounting and fixing a plate to the cover in a position that allows for performing the development step within the development chamber after closing the housing with the cover. By closing the housing with the cover the plate that is fixed to the cover will be inserted into the housing of the development chamber at a predetermined position, preferably with a border of the plate dipping into the solvent mixture for performing the development step. Thus, by monitoring the closure time of the development chamber with suitable sensors, the development process duration can be automatically determined and monitored by the data input unit.

It is also possible that the cover comprises a plate reception device that is suitable for moving a thin-layer chromatography plate between a storage position without contact to a solvent bath within the development chamber, and a development position with a part of the thin-layer chromatography plate immersed in the solvent bath. The plate reception device may be operated either manually or automatically and can be realized by using a lifting mechanism. Thus, is becomes possible to insert a thin-layer chromatography plate into the plate reception device and to put the cover onto the development chamber, whereby the thin-layer chromatography plate is positioned within a storage position without any contact to the solvent bath that is arranged within the development chamber. The duration of the development step with the thin-layer chromatography plate in contact with the solvent can be precisely adjusted by manually or automatically operating the plate reception device to move the thin-layer chromatography plate from the storage position into the development position and back into the storage position. Since the cover remains unchanged on the development chamber, there is no risk of accidental shock or impact to the development chamber or to the thin-layer chromatography plate during the development of the thin-layer chromatography plate.

According to a favorable aspect of the invention, the data input unit of the cover comprises a temperature sensor device for sensing the temperature inside the development chamber during the development process. According to yet another favorable aspect of the invention, the data input unit of the cover comprises a humidity sensor device for sensing the humidity inside the development chamber during the development process. It is well-known that the temperature and the humidity within a development chamber affect the performance of a thin-layer chromatography development step and the results from such a measurement. By integration of a temperature sensor device as well as of a humidity sensor device, information about these parameters can be automatically obtained and monitored during a development step. The costs for integrating such sensor devices into the cover is low, but the gain in better defined and more precise measurement results is high.

According to another embodiment of the invention, the data input unit of the cover comprises a pressure sensor device for sensing the pressure inside the development chamber during the development process. The cover can comprise a closure mechanism that provides for a pressure-tight closure of the housing of the development chamber. Such a closure mechanism may comprise a rotary knob which is operatively connected to locking means or detent means that engage with the housing after positioning the cover onto an opening of the housing. By rotating the rotary knob, the locking means or detent means engage with corresponding restraining means of the housing, resulting in a pressure-tight closure of the housing during the development step. It is also possible to provide for a closure of the development chamber by simply placing the cover on the opening of the housing, provided that the weight of the cover is sufficient large to prevent any unwanted uplift of the cover during the development of the thin-layer chromatography plate. The ring-like contact surface of the cover that is in contact with the development chamber can be coated with an elastic seal, resulting in an air-tight closure of the development chamber as soon as the cover is placed on top of the opening of the development chamber. By determining the pressure inside the development chamber, this data can be monitored during the development step and transferred to the thin-layer chromatography data storage device.

According to yet another embodiment of the invention, the data input unit of the cover comprises a bubble sensor device for sensing bubbles within the solvent inside the development chamber during the development process.

Such a bubble sensor device can determine the existence and possibly also the number or size of bubbles by optical means, e.g. by irradiating the solvent bath with a laser light beam and by determining and evaluating the light that is scattered from the bubbles. It is also possible to detecting bubbles by making use of appropriate ultrasonic sensors or by any other sensor that is suitable for detecting bubbles in the solvent bath. It has been found that the number of bubbles that are created during the development step within the solvent mixture affect the separation of analytes across the plate. Thus, this information can be determined automatically during the development step and added to the data compiled with the data input unit and subsequently transmitted to the thin-layer chromatography data storage device.

According to yet a further embodiment of the invention, the data input unit of the cover comprises a filling level sensor device for sensing the filling level of a solvent in a solvent bath within the development chamber. Such a filling level sensor can be an optical sensor that detects the filling level e.g. by detecting light from a laser light beam that is reflected from the surface of the solvent that has been filled into a cup for the solvent bath. The filling level sensor can also be a sensor with which an electrical conductivity changed by the solvent can be detected at one preset optimum filling level or at different heights of the filling level. By detecting and monitoring the filling level of the solvent bath, it is possible to monitor and verify a proper execution of the development step. If the filling level is too low or too high before or during the execution of the development step, a warning can be displayed or indicated with the cover.

In yet another embodiment of the invention, the data input unit of the cover comprises a solvent homogeneity sensor device for sensing the homogeneity of the solvent before or during the development step. The solvent that is used for developing the thin-layer chromatography plate is usually a mixture of two or more components. Proper development of the thin-layer chromatography plate and precise results require a homogeneous mixing of the components in the solvent. If such a solvent that is used for performing the development step does not meet the requirements with respect to homogeneity, a warning can be displayed or indicated with the cover.

According to yet another aspect of the invention, the cover comprises an orientation measurement device for measuring the orientation of the cover with respect to a reference orientation. The orientation measurement device can be a spirit level with an air bubble within a tubular housing filled with a liquid, whereby the air bubble is visible from outside the cover. For such a spirit level the reference orientation is a horizontal plane that is also parallel to a surface of the solvent within the solvent bath. The orientation measurement device can also be a gyroscope that determines the orientation of the cover with respect to a preset reference orientation, which allows for obtaining a precise information about any inclination of the development chamber that might be detrimental to the results of the development process.

In order to protect the data input unit from moisture or possibly hazardous substances, the cover optionally comprises a compartment for at least one sensitive part of the data input unit and of the data communication unit that is sealed from the inner side facing the development chamber with a sealing that is inert to the solvent. The sensitive part is preferably manufactured from materials with only low chemical resistance. Especially the electronic components can be arranged within such a sealed compartment, protecting the electronic components from moisture or liquids inside of the development chamber. The sensor devices can be arranged outside of such a sealed compartment and can be connected to the more sensitive parts of the data input unit via a wire connection or via a wireless connection for transmitting the sensor readings to a data processing unit or data storing unit of the data input unit that is arranged inside of the sealed compartment. The sealed compartment can be sealed with a sealing that cannot be opened or removed without destroying said sealing, which allows for a highly effective sealing. It is also possible that the compartment comprises an opening that can be opened or closed during the lifecycle of the cover, which allows for e.g. inserting and replacing a battery for the power supply of the data input unit. The opening can be closed by a pivotable or removable lid with an additional sealing that prevents the penetration of any moisture or liquid into the compartment. It is also possible to add charging coils into the compartment that allow for wireless charging of a rechargeable battery without the need to remove and replace the rechargeable battery.

In yet another embodiment of the invention, the sealing comprises a glass plate and an annular seal surrounding the glass plate that allows for sealing a gap between the glass plate and an opening edge of the opening of the development chamber. Such a glass plate provides for an economical and effective shielding of the compartment from most hazardous substances that might come into contact with the cover during use of the development chamber.

According to an advantageous aspect of the invention, the data communication unit comprises a data reception device for receiving data related to the thin-layer chromatography plate that is developed during the development process. Thus, the cover may receive data before performing a development step with one or more thin-layer chromatography plates loaded into the development chamber. Such data can comprise specific information about the thin-layer chromatography plate that will be processed and developed during the development step which can be used to calculate and preset one or more conditions for the development step, like e.g. the preferred duration time that is required for a favorable development of the thin-layer chromatography plate, i.e. for a separation of the analytes that allows for a simple and meaningful evaluation of the spots of different analytes that are spread along the travel direction of the mobile phase that is used for developing the thin-layer chromatography plate. Furthermore, such data might be received from a sample application device that allows for automatic sample delivery onto thin-layer chromatography plates. The data that is received from such a sample application device or from a device that allows for manual input of such parameters related to the thin-layer chromatography plate and the sample or the samples applied to the plate can be merged or combined with additional data that is entered or collected by the cover of the development chamber before, during or after a development step. The merged or combined data can then be transmitted to a thin-layer chromatography data storage device. This will significantly reduce any errors or incorrect entries before the evaluation of the results of the development of thin-layer chromatography plates.

The invention further relates to a system for developing and analyzing a thin-layer chromatography plate with a development chamber for developing the thin-layer chromatography plate and with a thin-layer chromatography evaluation device for collecting and analyzing results of chromatography on a thin-layer chromatography plate developed with the development chamber. Development chambers that are known from prior art comprise a housing for receiving the thin-layer chromatography plate and some solvent mixture that is required for developing the thin-layer chromatography plate during the development step. Such known development chambers comprise a cover that is designed for closing and possibly for sealing the development chamber during a development step in order to avoid any unwanted leakage of solvent vapors out of the development chamber and to prevent any unwanted disturbance or contamination of the development process inside the development chamber.

Any data acquisition of data that might be helpful for performing subsequent analysis of the thin-layer chromatography plate after the development within such a development chamber is usually performed separately and manually, e.g. by taking notes about the duration and conditions of the development process or about the solvent that is used for developing the thin-layer chromatography plate. However, such manual data acquisition is tedious and error-prone. If a large number of thin-layer chromatography plates is developed at the same time or within a short period of time, there is an increased risk of unintentional confusion of data, which may result in data from one measurement being erroneously assigned to another measurement.

According to a very favorable aspect of the invention, the development chamber of the system comprises a cover with features described above. Such a cover allows for entering or collecting additional information related to the thin-layer chromatography plate and the sample development during the development step that is performed by using the development chamber.

This will simplify the data gathering that is required for any subsequent data evaluation that will be performed manually or automatically on the basis of the data that is available and of the results of the thin-layer chromatography plate development that is performed with use of the development chamber with such a cover. Furthermore, the risk of improper or erroneous data colleting will be reduced, which facilitates the data gathering and the evaluation and analyzation of thin-layer chromatography results.

According to a favorable option of the invention, the thin-layer chromatography evaluation device comprises a data communication unit that enables a wireless data transmission of the data related to the evaluation process to a thin-layer chromatography data storage device. Thus, the system according to the invention provides for means for automatic or aided data acquisition related to a development step that is performed with the development chamber, and for means for automatic data transfer of all data that has been entered or collected with the development chamber to a data storage device. This can significantly reduce both the workload involved in performing and recording a development step and any potential sources of error during or after data acquisition that is necessary or helpful for subsequent evaluation of the results.

The invention also relates to a method for developing a thin-layer chromatography plate within a development chamber. Usually, all data that is relevant for subsequent evaluation of the developed thin-layer chromatography plate must be manually recorded and afterwards manually entered into a thin-layer chromatography evaluation device that is used for performing the evaluation and analysis of the developed thin-layer chromatography plate.

Accordingly, there is a need for reducing the workload and for reducing possible errors when performing and monitoring a development step with a development chamber.

The invention relates to developing a thin-layer chromatography plate with within a thin-layer chromatography development chamber, whereby a cover as described above is used for closing and sealing the housing of the development chamber during the development step, and whereby at least one data related to the development step is entered into a data input unit or collected by the data input unit within the cover of the development chamber. According to a very favorable aspect of the invention, during a data transmission step at least one data related to the development of the thin-layer chromatography plate that is entered or collected by the data input unit of the cover is transmitted during or after the development step to a thin-layer chromatography evaluation device for collecting and analyzing the results of chromatography of the thin-layer chromatography plate.

### BRIEF DESCRIPTION OF THE DRAWINGS

The present invention will be more fully understood, and further features will become apparent, when reference is made to the following detailed description and the accompanying drawings. The drawings are merely representative and are not intended to limit the scope of the claims. In fact, those of ordinary skill in the art may appreciate upon reading the following specification and viewing the present drawings that various modifications and variations can be made thereto without deviating from the innovative concepts of the invention. Like parts depicted in the drawings are referred to by the same reference numerals.

FIG. 1 illustrates a schematic section view of a thin-layer chromatography development chamber with a housing and with a cover that covers an opening of the housing and that comprises a data input unit for entering or collecting data related to the and a data communication unit that enables a wireless data transmission,

FIG. 2 illustrates a perspective view of the cover as shown in FIG. 1,

FIG. 3 illustrates a perspective view of another embodiment of the cover,

FIG. 4 illustrates a schematic representation of a method for developing and analyzing a thin-layer chromatography plate, and

FIG. 5 illustrates a schematic section view of the thin-layer chromatography development chamber that is covered with another embodiment of the cover.

### DETAILED DESCRIPTION OF THE INVENTION

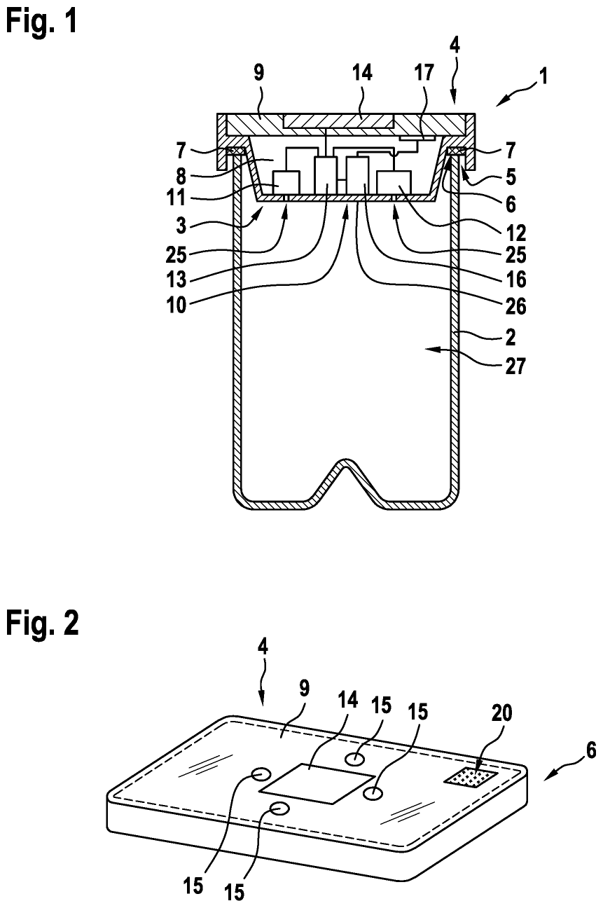

FIG. 1 illustrates an embodiment of a thin-layer chromatography development chamber 1 that is designed and suitable for developing thin-layer chromatography plates. The development chamber 1 comprises a housing 2 with an opening 3 on a top side of the housing 2. The housing 2 is large enough to receive several thin-layer chromatography plates and a solvent forming the mobile phase for developing the thin-layer chromatography plates within the development chamber 1. The thin-layer chromatography plates and the solvent can be inserted through the opening 3 into the housing 2. Afterwards, the opening 3 can be closed and sealed by a cover 4 in order to avoid any interference or contamination during development of the thin-layer chromatography plates inside of the development chamber 1.

The cover 4 has a circumferential groove 5 designed to receive an upper edge 6 of the housing 2, with an elastic seal 7 arranged within the groove 5. The groove 5 is designed to allow a clampable sealing to be used simplifying sealing swap procedure. The cover 4 can be placed on top of the housing 2, thereby covering the opening 3 and sealing the opening 3 with the elastic seal 7 that is clamped within the circumferential groove 5 by the weight of the cover 4. The sealing of the cover 4 generates a contact pressure and a retention force that withstands a pressure which might arise within the housing 2 during a development step that is performed with the development chamber 1, resulting in a firm and reliable closure of the development chamber 1.

The cover 4 comprises a compartment 8 below a front plate 9 that provides for a closure of the compartment 8. A data input unit 10 is arranged inside the compartment 8. The data input unit 10 comprises a temperature sensor 11, a pressure sensor 12, a data processing unit 13, a display 14 and several touch-sensitive buttons 15. A user can enter some data related to the development step that is performed with the development chamber 1 by using the touch-sensitive buttons 15. The data can be displayed with the display 14. Furthermore, additional data can be collected with the temperature sensor 11 and the pressure sensor 12 before, during or after the development step. The data input unit 10 is connected with a data communication unit 16 and an antenna 17 that allows for a wireless data transmission of some or all of the data that has been entered into or collected by the data input unit 10 to a thin-layer chromatography data storage device or a thin-layer chromatography evaluation device which is not shown in FIG. 1.

By arranging the data input unit 10 within the compartment 8, the data input unit 10 is protected against mechanical stress and against interference or damage by solvents or ingredients that are used during a development step that is performed with the development chamber 1. The temperature sensor 11 and the pressure sensor 12 are each arranged above a small hole 25 within a bottom wall 26 of the compartment 8. Each sensor 11, 12 interacts with an interior space 27 inside the housing 2 through the corresponding hole 25. Furthermore, each sensor 11, 12 covers the respective hole 25 and provides for a sealing that protects the inside of the compartment 8 against solvent vapor. As handling the cover 4 and closing the development chamber 1 with the cover 4 is mandatory for developing a thin-layer chromatography plate, entering data is facilitated by allowing manual data input via the touch-sensitive buttons 15. Automatic or manually triggered data collection by the temperature sensor 11 and the pressure sensor 12 further facilitates the gathering of data that can be relevant for evaluation of a thin-layer chromatography plate after developing said plate within the development chamber 1 that is closed and sealed by the cover 4. All data can be transferred from the data input unit 10 to the data storage device or to the evaluation device by the data communication unit 16, whereby the data transfer is either automatically or after manually triggered and performed by the data communication unit 16.

FIG. 2 illustrates a perspective view of the cover 4 with the display 14 and the touch-sensitive buttons 15 arranged within a front plate 9 made of glass.

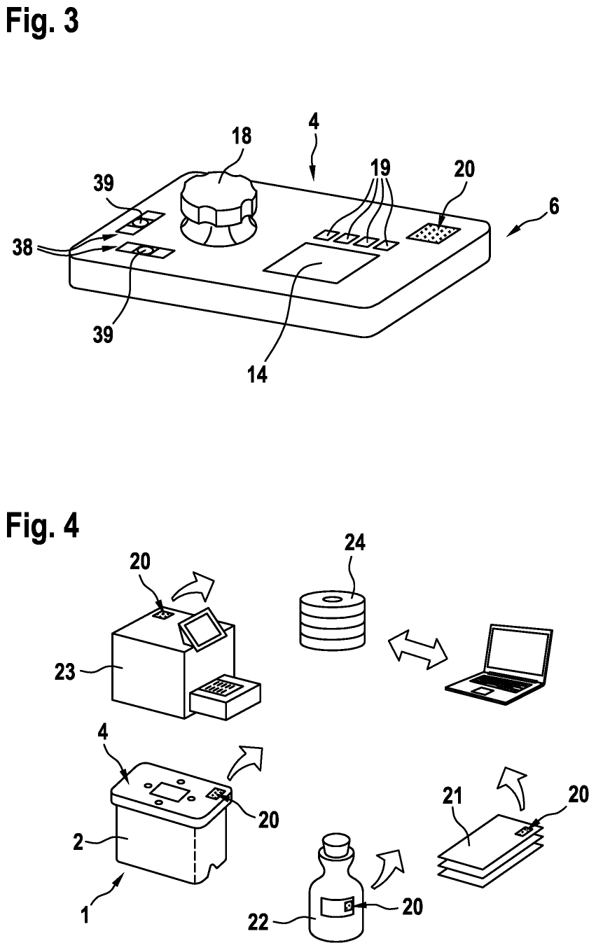

FIG. 3 illustrates a perspective view of another embodiment of the cover 4 with a rotary knob 18 that can be used for handling of the cover 4 and for closing and sealing the opening 3 of the housing 2 of the development chamber 1. The rotary knob 18 allows for actuating pressure pads to be pressed against the housing 2, resulting in an enhanced contact pressure and retention force that is generated by the cover 4 and supports a firm and reliable closure of the housing 2 with the cover 4. Furthermore, the cover 4 comprises several buttons 19 that can be manually pressed or released by a user. The cover 4 also comprises two spirit levels 38 indicating an undesired inclination of the cover 4 with an air bubble 39 inside a tubular housing that is filled with a liquid.

In FIG. 4, a main advantage of using the cover 4 is illustrated. All parts, components and equipment that are used during the preparation of a thin-layer chromatography plate, of the development of said thin-layer chromatography plate and of the evaluation and analysis of the developed thin-layer chromatography plate can be identified and corresponding data can be compiled and taken into consideration for analyzing the results. The identification can be performed by making use of e.g. an individual two-dimensional barcode 20 that is attached to the thin-layer chromatography plates 21 that are used for analyzing a sample. A further barcode 20 is attached to the solvent container 22 with a solvent that is used for developing the thin-layer chromatography plate 21 with the sample. Yet another barcode 20 is attached to the front plate 9 of the cover 4 that is used to close the development chamber 1 during the development step. An additional barcode 20 is attached to an evaluation device 23 that is used for illuminating and evaluating the thin-layer chromatography plate 21 after performing the development step with the development chamber 1. Each of these barcodes 20 can be read with a barcode reader. Each individual barcode 20 can be referenced with additional information about the corresponding component or equipment. Thus, all information that is relevant for a development and analysis of a thin-layer chromatography plate 21, e.g. about the thin-layer chromatography plate 21 itself, the solvent used for the development within the development chamber 1 and the evaluation device 23 used for evaluation of the developed thin-layer chromatography plate 21 can be referenced and collected via the barcodes and can be transferred to a thin-layer chromatography data storage device 24. This data is then available and can be accessed for performing an analysis of the results any time. It is also possible to make use of other two-dimensional codes like e.g. QR-codes or data matrix codes instead of two-dimensional bar codes 20. Furthermore, it is also possible to make use of non-optical coding methods like radio-frequency identification, near-field communication or magnetic stripes that allow for a contact-less identification.

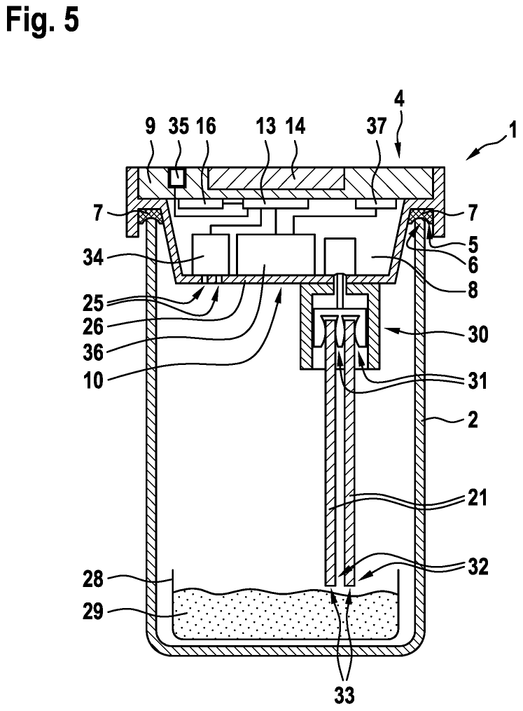

FIG. 5 illustrates another embodiment of the development chamber 1 with another embodiment of the cover 4 that is also designed and suitable for developing thin-layer chromatography plates 21. All features that are not shown or referenced in FIG. 5 or that are not explicitly described below can be identical to those of the embodiment shown in FIG. 1. The development chamber 1 comprises a housing 2 with a cup 28 that can be filled with a solvent 29 to provide for a solvent bath at the bottom of the development chamber 1. A plate reception device 30 is mounted at the bottom wall 26 of the compartment 8 that is facing the interior space 27 of the development chamber 1. The plate reception device 30 comprises slots 31 for receiving and fixing a thin-layer chromatography plate 21 within a corresponding slot 31. The plate reception device 30 comprises a lifting mechanism that allows for lowering a small region 32 next to a lower edge 33 of the thin-layer chromatography plates 21 into the solvent 29 within the cup 28. After performing the development step, the thin-layer chromatography plates 21 can be lifted upwards with the plate reception device 30 which removes the lower edge 33 from the solvent bath and stops any further contact of the thin-layer chromatography plate 21 with the solvent bath.

The cover 4 comprises a combined optical sensor device 34 that projects a laser beam through a first hole 25 in the bottom wall 26 into the solvent bath below, and that detects a returned laser light intensity that is reflected from the surface of the solvent 29 or scattered by bubbles within the volume of the solvent 29. Thus, the combined optical sensor device 34 can be used as filling level sensor device and as solvent homogeneity sensor device for monitoring the amount and usage of the solvent 29 during the development step.

The cover 4 also comprises a status indication unit 35 with a light emitting diode. Illumination with green light corresponds to an on-state of the cover 4. Illumination with different light, e.g. with red light, or with intermittently flashing light emissions corresponds to a malfunction that has been detected before or during execution of a development step.

Within the compartment 8 there is a rechargeable battery 36 that can be recharged with a wireless recharging unit 37 comprising a receiving coil for inductive charging of the battery 36.

1. Cover (4) for a thin-layer chromatography development chamber (1) for developing thin-layer chromatography plates (21) by introducing a liquid solvent onto a thin-layer chromatography plate (21), whereby the solvent and the thin-layer chromatography plate (21) can be inserted into the development chamber (1), and whereby an opening (3) of the development chamber (1) can be closed with the cover (4), characterized in that the cover (4) comprises a data input unit (10) for entering or collecting data related to a development process performed within the development chamber (1).

2. Cover (4) according to claim 1, characterized in that the cover (4) comprises an information display unit (14) for displaying data that has been entered or collected with the data input unit (10).

3. Cover (4) according to claim 1, characterized in that, the cover (4) comprises a data communication unit (16) that enables a wireless data transmission of the data that has been entered or collected with the data input unit (10) to a thin-layer chromatography data storage device (24).

4. Cover (4) according to claim 1, characterized in that the data input unit (10) of the cover (4) comprises a timer device that can be set to indicate the development process duration.

5. Cover (4) according to claim 1, characterized in that the cover (4) comprises a plate reception device (30) that is suitable for moving a thin-layer chromatography plate (21) between a storage position without contact to a solvent (29) of a solvent bath within the development chamber (1), and a development position with a part of the thin-layer chromatography plate (21) immersed in the solvent (29) of the solvent bath.

6. Cover (4) according to claim 1, characterized in that the data input unit (10) of the cover (4) comprises a temperature sensor device (11) for sensing the temperature inside the development chamber (1) during the development process.

7. Cover (4) according to claim 1, characterized in that the data input unit (10) of the cover (4) comprises a humidity sensor device for sensing the humidity inside the development chamber (1) during the development process.

8. Cover (4) according to claim 1, characterized in that the data input unit (10) of the cover (4) comprises a pressure sensor device (12) for sensing the pressure inside the development chamber (1) during the development process.

9. Cover (4) according to claim 1, characterized in that the data input unit (10) of the cover (4) comprises a bubble sensor device for sensing bubbles within a solvent (29) inside the development chamber (1) during the development process.

10. Cover (4) according to claim 1, characterized in that the data input unit (10) of the cover (4) comprises a filling level sensor device for sensing the filling level of a solvent (29) in a solvent bath within the development chamber (1).

11. Cover (4) according to claim 1, characterized in that the data input unit (10) of the cover (4) comprises a solvent homogeneity sensor device (34) for sensing the homogeneity of a solvent (29) before or during the development step.

12. Cover (4) according to claim 1, characterized in that the cover (4) comprises an orientation measurement device for measuring the orientation of the cover (4) with respect to a reference orientation.

13. Cover (4) according to claim 1, characterized in that the cover (4) comprises a compartment (8) for at least one sensitive part, of the data input unit (10) and of the data communication unit (16) that is sealed from the inner side facing the development chamber (1) with a sealing that is inert to the solvent.

14. Cover (4) according to claim 1, characterized in that the sealing comprises a glass plate and an annular seal surrounding the glass plate that allows for sealing a gap between the glass plate and an opening edge of the opening (3) of the development chamber (1).

15. Cover (4) according to claim 1, characterized in that the data communication unit (16) comprises a data reception device for receiving data related to the thin-layer chromatography plate (21) that is developed during the development process.

16. System for developing and analyzing a thin-layer chromatography plate (21) with a development chamber (1) for developing the thin-layer chromatography plate (21) and with a thin-layer chromatography evaluation device (23) for collecting and analyzing results of chromatography on a thin-layer chromatography plate (21) developed with the development chamber, characterized in that the development chamber (1) comprises a cover (4) according to claim 1.

17. System for developing and analyzing a thin-layer chromatography plate (21) according to claim 16, characterized in that the thin-layer chromatography evaluation device (23) comprises a data communication unit that enables a wireless data transmission of the data related to the evaluation process to the thin-layer chromatography data storage device (24).

18. Method for developing and analyzing a thin-layer chromatography plate (21), whereby the thin-layer chromatography plate (21) is developed within a thin-layer chromatography development chamber (1) with a cover (4) according to claim 1, characterized in that during a data transmission step at least one data related to the development of the thin-layer chromatography plate (21) that is entered or collected by the data input unit (10) of the cover (4) is transmitted during or after the development step to a thin-layer chromatography evaluation device (23) for collecting and analyzing the results of chromatography of the thin-layer chromatography plate (21).
